(19) United States
(12) Patent Application Publication
(10) Pub. No.: US 2026/0095735 A1
(43) Pub. Date: Apr. 2, 2026

(54) SYSTEM AND METHOD FOR PROVIDING IOT EMERGENCY SMS SERVICE WITHOUT SUBSCRIBER IDENTITY OF NETWORK REGISTRATION IN MOBILE NETWORKS

(71) Applicant: DISH Wireless L.L.C., Englewood, CO (US)

(72) Inventors: Borong Zheng, Littleton, CO (US); Mohammad Dawood Shahdad, Aurora, CO (US); Sundeep Goswami, Leesburg, VA (US)

(21) Appl. No.: 18/905,030

(22) Filed: Oct. 2, 2024

(51) Int. Cl. H04W 4/90; H04W 64/00

(52) U.S. Cl. CPC H04W 4/90; H04W 64/003

(57) ABSTRACT

Embodiments are directed towards systems and methods for providing IoT emergency text service without subscriber identity of network registration in mobile networks. The system enables text-to-emergency services for both registered and unregistered IoT devices, including devices without Subscriber Identity Module (SIM) cards or with invalid SIM cards. By establishing an emergency PDU session between the IoT device and the mobile packet core, the system supports emergency data session setups for both registered and unregistered IoT devices. This emergency PDU session provides a prioritized managed data connection for transporting emergency text messages and includes automated location reporting of the IoT device. The system is fully compliant with 3GPP standards and applicable to all IoT devices categories.

### BACKGROUND

The current 3GPP standard defines emergency procedures for User Equipment (UE) making emergency calls, covering scenarios for both registered UEs and unregistered UEs that fail to register to the serving network. These procedures accommodate cases such as lack of service agreements (e.g., roaming) between serving and home networks, home network outages, or the absence of a valid SIM card. However, these emergency call procedures only cover voice calls, such as 911 calls in North America.

Some carriers extend beyond voice emergency calls by providing text-to-emergency services, such as text-to-911. This service allows registered UEs to send SMS texts using emergency short codes (e.g., 911), which are routed as regular SMS messages to emergency service entities such as Public Safety Answering Points (PSAP) in North America. However, this practice does not cover cases where the UE cannot register to the service network, treats emergency texts the same as regular texts, lacks priority treatment, and only applies to registered UEs.

There is a continuing need to address these text-to-emergency services issues with some type of technological improvement that will overcome these issues. Unfortunately, a full solution to these end user experience problems of these text-to-emergency services has yet to be produced. The present disclosure addresses this and other issues.

### BRIEF SUMMARY

The present disclosure relates generally to telecommunication networks, more particularly, to a system and method for emergency call procedures in mobile networks. To address the limitations of current 3GPP emergency procedures and industry practices of IoT text-to-emergency services, the proposed disclosure offers a comprehensive solution that supports unregistered IoT devices, including IoT devices without SIM cards or with invalid SIM cards.

Briefly stated, one or more methods for providing IoT emergency text service without subscriber identity of network registration in mobile networks are disclosed. Some such methods include: identifying, via an IoT device, an emergency condition; establishing an emergency Protocol Data Unit (PDU) session, via the IoT device, with a mobile packet core using standard 3GPP procedures that support both registered and unregistered IoT devices; providing, via the emergency PDU session, a managed data connection between the IoT device and an emergency service provider with priority over regular data connections; transporting an IoT emergency text message as data payload over the emergency PDU session; and performing, via the packet core, network-induced location requests (NI-LR) during the emergency PDU session setup that enable automated location reporting of the IoT device.

In one or more embodiments of the method for providing IoT emergency text service without subscriber identity of network registration in mobile networks, the IoT device includes a sensor that is selected from one or more of: an industrial sensor, a power transmission plant sensor, a home security sensor, a vehicle sensor, or an aircraft sensor. In another aspect of some embodiments, the method further comprises: sending the IoT emergency text message using non-IP stack based communication. In still another aspect of some embodiments, the non-IP stack based communication is one or more of: narrowband IoT network communication, non-continuous communication, limited bandwidth communication, wide area communication, hub-free communication, and NIDD communication. In yet another aspect of some embodiments, the method further comprises: providing priority treatment to the emergency text payload by leveraging priority treatment for the emergency PDU session.

In some embodiments, the method for providing IoT emergency text service without subscriber identity of network registration in mobile networks further comprises: providing IoT device location reporting by leveraging the emergency PDU session triggered Network Induced Location Request (NI-LR) process. In another aspect of some embodiments, the method further comprises: enabling unregistered IoT devices to perform emergency registration towards the core network. In still another aspect of some embodiments, the method further comprises: enabling emergency registration of the IoT device without requiring subscription authentication. In yet another aspect of some embodiments, the method further comprises: enabling an emergency PDU session from an emergency registered IoT device, and preventing an emergency PDU session from IoT devices other than the emergency registered IoT device.

In other embodiments, a system for providing IoT emergency text service without subscriber identity of network registration in mobile networks is disclosed. The system includes a memory that stores computer-executable instructions; and a processor that executes the computer-executable instructions that cause the processor to: establish an emergency PDU session, via the IoT device, with a mobile packet core using standard 3GPP procedures that support both registered and unregistered IoT devices; provide, via the emergency PDU session, a managed data connection between the IoT device and an emergency service provider with priority over regular data connections; transport an IoT Emergency text message as data payload over the emergency PDU session; and perform, via the packet core, network-induced location requests (NI-LR) during the emergency PDU session setup that enable automated location reporting of the IoT device.

In one or more embodiments of the system for providing IoT emergency text service without subscriber identity of network registration in mobile networks, the IoT device includes a sensor that is selected from one or more of: an industrial sensor, a power transmission plant sensor, a home security sensor, a vehicle sensor, or an aircraft sensor. In another aspect of some embodiments, the IoT emergency text messages are sent using non-IP stack based communication. In still another aspect of some embodiments, the non-IP stack based communication is one or more of: narrowband IoT network communication, non-continuous communication, limited bandwidth communication, wide area communication, hub-free communication, and NIDD communication. In yet another aspect of some embodiments, priority treatment is provided to the emergency text payload by leveraging priority treatment for the emergency PDU session.

In some embodiments of the system for providing IoT emergency text service without subscriber identity of network registration in mobile networks, the IoT device location reporting is provided by leveraging the emergency PDU session triggered Network Induced Location Request (NI-LR) process. In another aspect of some embodiments, the system enables unregistered IoT devices to perform emergency registration towards the core network. In still another aspect of some embodiments, the system enables emergency registration of the IoT device without requiring subscription authentication. In yet another aspect of some embodiments, the system enables an emergency PDU session from an emergency registered IoT device, and preventing an emergency PDU session from IoT devices other than the emergency registered IoT device.

Moreover, in still other embodiments, one or more non-transitory computer-readable storage mediums are disclosed. The one or more non-transitory computer-readable storage mediums have computer-executable instructions stored thereon that, when executed by a processor, cause the processor to: establish an emergency PDU session, via the IoT device, with a mobile packet core using standard 3GPP procedures that support both registered and unregistered IoT devices; provide, via the emergency PDU session, a managed data connection between the IoT device and an emergency service provider with priority over regular data connections; and transport an IoT emergency text message as data payload over the emergency PDU session.

In one or more embodiments of the system for providing IoT emergency text service without subscriber identity of network registration in mobile networks, the non-transitory computer-readable storage medium includes further computer-executable instructions that, when executed by a processor, cause the processor to: perform, via the packet core, network-induced location requests (NI-LR) during the emergency PDU session setup that enable automated location reporting of the IoT device.

In one or more embodiments, the IoT device includes a sensor that is selected from one or more of: an industrial sensor, a power transmission plant sensor, a home security sensor, a vehicle sensor, or an aircraft sensor. In another aspect of some embodiments, the IoT emergency text messages are sent using non-IP stack based communication. In still another aspect of some embodiments, the non-IP stack based communication is one or more of: narrowband IoT network communication, non-continuous communication, limited bandwidth communication, wide area communication, hub-free communication, and NIDD communication. In yet another aspect of some embodiments, priority treatment is provided to the emergency text payload by leveraging priority treatment for the emergency PDU session.

In some embodiments, the IoT device location reporting is provided by leveraging the emergency PDU session triggered Network Induced Location Request (NI-LR) process. In another aspect of some embodiments, the system enables unregistered IoT devices to perform emergency registration towards the core network. In still another aspect of some embodiments, the system enables emergency registration of the IoT device without requiring subscription authentication. In yet another aspect of some embodiments, the system enables an emergency PDU session from an emergency registered IoT device, and preventing an emergency PDU session from IoT devices other than the emergency registered IoT device.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed system and method, reference will be made to the following Detailed Description, which is to be read in association with the accompanying drawings:

FIG. 1 illustrates a context diagram of an environment in which a system for providing Emergency text service without subscriber identity of network registration in mobile networks may be implemented in accordance with embodiments described herein.

FIG. 2 illustrates a diagram of an example prior art system architecture for SMS-to-emergency service.

FIG. 3 illustrates a communication flow within a prior art system architecture for SMS-to-emergency service, with high-level call flow for a legacy text-to-emergency service.

FIG. 4 illustrates a communication flow within a prior art system architecture for SMS-to-emergency service.

FIG. 5 illustrates a diagram of a system for providing emergency text service with or without subscriber identity of network registration in mobile networks.

FIG. 6 illustrates a communication flow within a system for providing emergency text service with subscriber identity of network registration in mobile networks with normal UE registration.

FIG. 7 illustrates a communication flow within a system for providing emergency text service without subscriber identity of network registration in mobile networks with rejected UE registration.

FIG. 8 illustrates a diagram of a system for providing emergency IoT Service with or without subscriber identity of network registration in mobile networks using SMS over unstructured data delivery mechanism.

FIGS. 9A and 9B illustrate a communication flow within a system for providing emergency IoT service with subscriber identity of network registration in mobile networks.

FIGS. 10A and 10B illustrate a communication flow within a system for providing emergency IoT service without subscriber identity of network registration in mobile networks.

FIG. 11 is a logic diagram showing number sequencing data flow between certain telecommunication network components during emergency text service without subscriber identity of network registration in mobile networks.

FIG. 12 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Advanced cellular networks provide a broad range of wireless services delivered to the end user across multiple access platforms and multi-layer networks. For example, 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible, and virtual RAN with interfaces creating additional data access points. 5G network functions may be completely software-based and designed as cloud-native, meaning that they’re agnostic to the underlying cloud infrastructure, allowing higher deployment agility and flexibility. With the advent of 5G, industry experts defined how the 5G Core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations. Future network architectures, such as 6G and others, are expected to utilize many of these features and functionalities.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them. This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices inherent to 5G deployment and the rise of IoT.

The 3rd Generation Partnership Project (3GPP) develops protocols for mobile telecommunications and has developed a standard for 5G. The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open-source development, ultimately to ease the deployment of new features and technology with scale. The O-RAN ALLIANCE objective is to allow multi-vendor deployment with off-the-shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises a set of radio base stations (each known as Next Generation Node B (gNB)) connected to the 5G Core (5GC) and to each other. The gNB incorporates three main functional modules: the Centralized Unit (CU), the distributed Unit (DU), and the Radio Unit (RU), which can be deployed in multiple combinations. The primary interface is referred to as the F1 interface between DU and CU and are interoperable across vendors. The CU may be further disaggregated into the CU user plane (CU-UP) and CU control plane (CU-CP), both of which connect to the DU over F1-U and F1-C interfaces, respectively. This 5G RAN architecture is described in 3GPP TS 38.401 V16.8.0 (2021-12). Each network function (NF) is formed by a combination of small pieces of software code called microservices. Future network architectures, such as 6G and others, are expected to utilize many of these technological improvements, plus additional advancements.

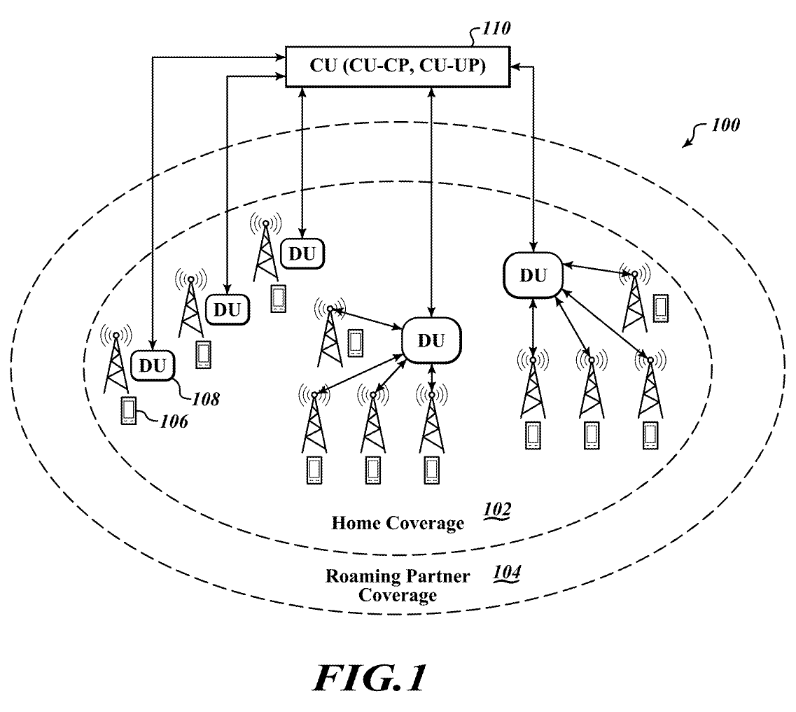

FIG. 1 illustrates a context diagram of an environment in which a system for providing emergency text service without subscriber identity of network registration in mobile networks may be implemented in accordance with embodiments described herein. A given area 100 will mostly be covered by two or more mobile network operators’ wireless networks. Generally, mobile network operators have some roaming agreements that allow users to roam from home network to partner network under certain conditions, shown in FIG. 1 as home coverage area 102 and roaming partner coverage area 104. Operators may configure the mobile user’s device, referred to herein as user equipment (UE), such as UE 106, with priority and a designated roaming partner network that is used in the roaming partner network coverage area 104. If a UE (e.g., UE 106) cannot find the home network coverage area 102, the UE will be transferred to a partner roaming network in the roaming partner coverage area 104. Thus, service coverage is maintained even if the home coverage area 102 is providing unsatisfactory service coverage.

As shown in FIG. 1, a 5G RAN is split into DUs (e.g., DU 108) that manage scheduling of all the users and a CU 110 that manages the mobility and radio resource control (RRC) state for all the UEs. The RRC is a layer within the 5G NR protocol stack. It exists only in the control plane, in the UE and in the gNB. The behavior and functions of RRC are governed by the current state of RRC. In 5G NR, RRC has three distinct states: RRC_IDLE, RRC_CONNECTED and RRC_INACTIVE.

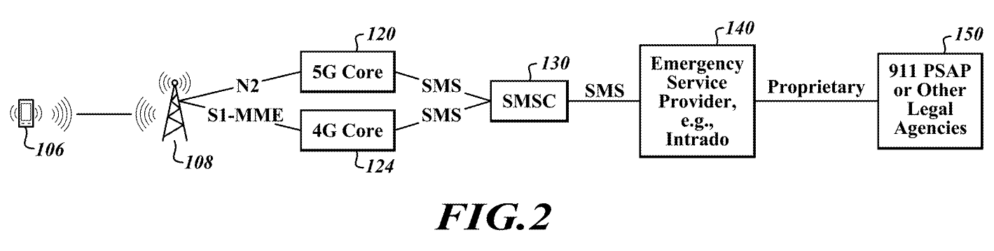

FIG. 2 illustrates a diagram of an example prior art system architecture for SMS-to-emergency service. Specifically, FIG. 2, shows prior art 911 SMS (SMS-to-Emergency) architecture using legacy SMS technologies to deliver emergency text. In this prior art configuration, a UE 106 sends an emergency text to a DU 108, which is shown as a radio tower a representing a Radio Access Network (RAN). A 5G RAN is called a gNB, which can be deployed optionally using O-RAN model where the gNB is decoupled into units of RU, DU, and CU. Alternatively, the gNB can be deployed in monolithic model, where is generically called gNB. The CU 110 or gNB has the interface N2 to the 5G Core. The 4G RAN is called a eNB, which has a S1-MME interface with 4G Core.

In a 5G embodiment, the DU 108 sends the emergency text via an N2 connection to a 5G Core 120. In the 4G embodiment, the DU 108 sends the emergency text via an S1-MME connection to a 4G Core 124. In both the 5G and 4G embodiments, the emergency text is next transmitted to the legacy Short Message Service Center (SMSC) 130. The SMSC 130 then transmits the emergency text to an Emergency Service Provider 140 (e.g., Intrado). Finally, the Emergency Service Provider 140 then forwards the emergency text to a 911 Primary Public Safety Answering Point (PSAP) 150 for emergency handling.

In summary, the legacy text-to-emergency services work as follows, first UEs 106 must be registered to the home network via the serving network. Next, UEs 106 send an SMS message to emergency codes (e.g., 911). Continuing, for SMS over IP, the SMS message is forwarded to an IMS (IP Multimedia Subsystem) and routed to the destination emergency entity as a regular SMS short code. For 5G networks with SMS over Non-Access Stratum (NAS), the SMS message is forwarded to the serving Access and Mobility Management Function (AMF), then to the serving Short Message Service Function (SMSF), and finally to the Short Message Service Center (SMSC), from where the SMS message is routed to the emergency service entity. For 4G networks with SMS over NAS, the SMS message is forwarded to the serving Mobility Management Entity (MME), then to the SMSC, and routed to the emergency service entity.

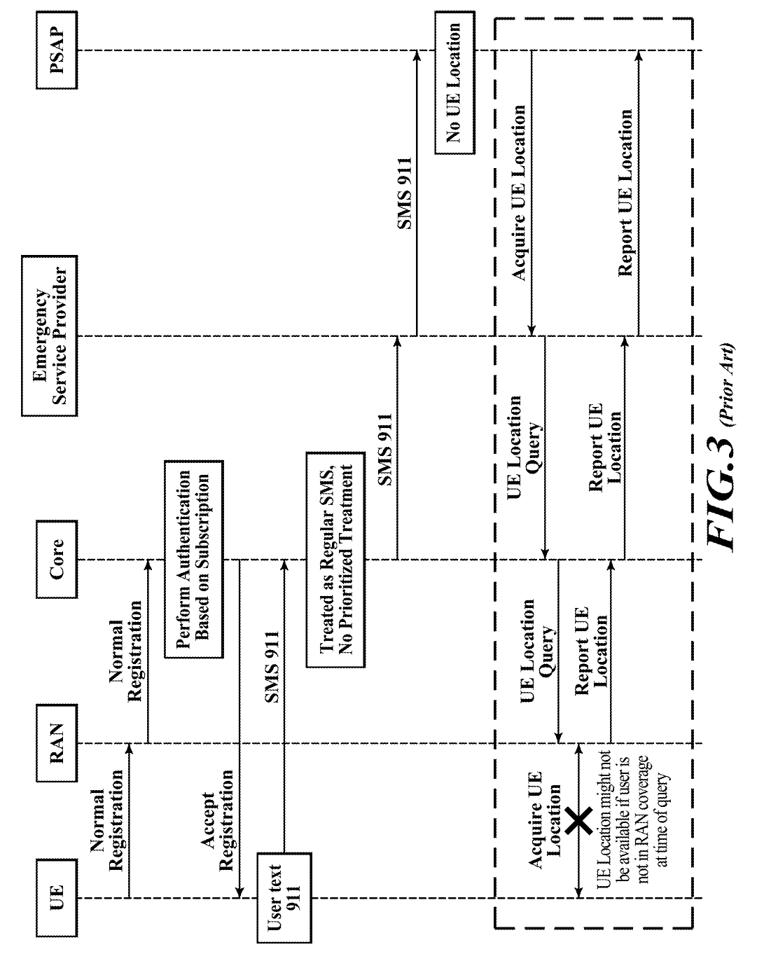

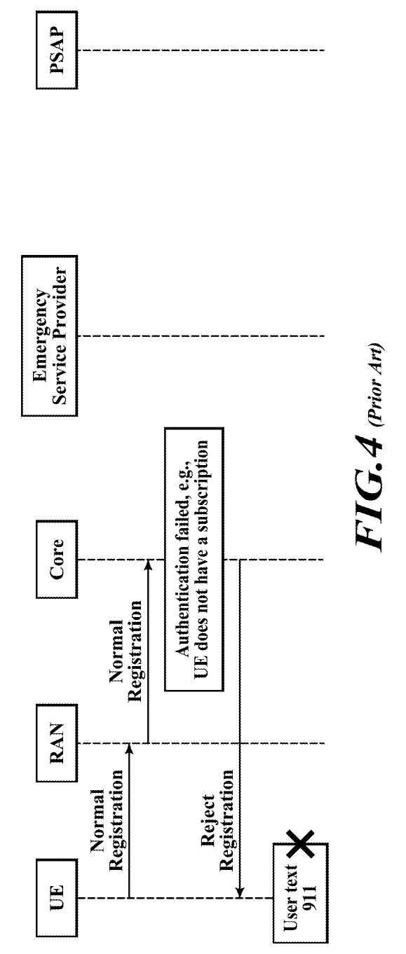

However, the legacy text-to-emergency services have significant limitations. For example, legacy text-to-emergency services do not support emergency registration procedures. Thus, if the UE 106 is not registered, the UE 106 has no SIM card, or an invalid SIM card, such emergency registration services are unavailable. Additionally, in legacy text-to-emergency systems, an emergency SMS message is treated with the same priority as a regular SMS message, with risk of delayed delivery during network congestion, lack of assurance for timely response, and failure to meet regulatory and safety standards. Furthermore, in the legacy text-to-emergency systems, the UE location is not available when the SMS message is received. In contrast, the emergency service entity needs to query the mobile network to acquire the UE location, which may not be possible if the connection is no longer available. Finally, the text-to-emergency service are only available for regular mobile UE categories and not for narrowband UE categories. Referring next to FIGS. 3 and 4, the limitations of legacy text-to-emergency systems are further explained.

FIG. 3 illustrates a communication flow within a prior art system architecture for SMS-to-Emergency service. Specifically, FIG. 3 provides the high-level call flow for a legacy Text-to-Emergency service. FIG. 3 clearly shows that in the legacy Text-to-Emergency system, an emergency text does not receive priority treatment, thereby resulting in delayed delivery during network congestion, lack of assurance for timely response, and failure to meet regulatory and safety standards. Additionally, FIG. 3 clearly shows that in the legacy Text-to-Emergency system, there is no UE location reported when an emergency text is received by a PSAP. Finally, in the legacy Text-to-Emergency system, a subsequent UE location poll might fail since the UE 106 might not always be in radio coverage in an emergency situation.

FIG. 3 shows that when a normal registration is sent from the UE to the RAN to the core, authentication is performed based on subscription. Accordingly, an emergency text for a UE 106 that is without a subscription will be rejected. Additionally, even if the UE 106 does have a subscription and is authenticated, so the UE 106 can be registered, when the user of the UE 106 sends an emergency text message, the emergency text message is treated as a regular SMS message with no prioritized treatment. Furthermore, even if the emergency text message sent by the UE 106 does reach the emergency service provider and the PSAP without prioritized treatment, there will be no UE location information provided with the emergency text message. While the legacy Text-to-Emergency system may attempt to acquire UE location information by sending a request back down through the communication link, the UE location may no longer by available if the user is not in RAN coverage at the time of the query.

FIG. 4 illustrates a communication flow within a prior art system architecture for SMS-to-emergency service. Specifically, FIG. 4 shows lack of support for an unregistered UE 106 when it does not have a subscription to the RAN/Core Network, or subscription authentication failure occurs due to network reasons. In this regard, subscription authentication failure may occur due to a lack of subscription. Additionally, subscription authentication failure may occur due to lack of SIM card or an invalid SIM card. Moreover, subscription authentication failure may occur due to a core network database failure. Finally, subscription authentication failure may occur due to lost connectivity to home network in the case of roaming.

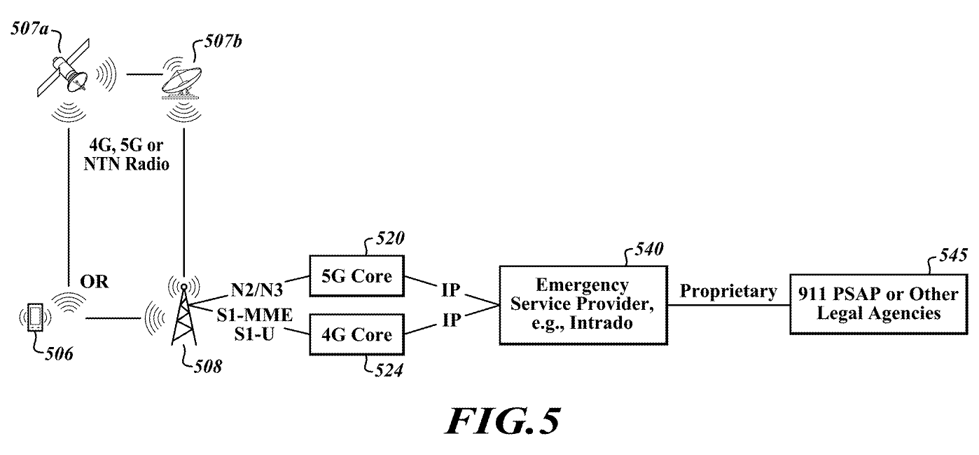

Referring now to FIG. 5, a system architecture is shown for providing emergency text service with or without subscriber identity of network registration in mobile networks. Specifically, FIG. 5 shows the system architecture for an enhanced SMS-to-emergency service, as well as improved text-to-emergency flows that provide technological improvement with respect to support for unregistered UE, prioritized emergency text treatment, and UE location services.

Major Architecture technological improvements that are provided by the enhanced SMS-to-emergency system include the replacement of legacy SMS technology with text over IP technology. Additional technological improvements that are provided by the enhanced SMS-to-emergency system include enabling support for registered and unregistered UEs early-on UE location reporting. In prior art, early-on UE location reporting was not available for registered UEs. Furthermore, technological improvements that are provided by the enhanced SMS-to-emergency system also include enabling prioritized treatment for the emergency text by piggy-backing on the existing priority treatment of emergency PDU sessions.

In one embodiment of the enhanced SMS-to-emergency system configuration, a UE 506 sends an emergency text to a DU 508. In another such embodiment, a UE 506 sends an emergency text to satellite 507a that is in turn transmitted to a satellite receiver 507b, and finally sent to the DU 508. This transmission may be 4G, 5G, 5G+, or NTN radio. In a 5G embodiment, the DU 508 sends the emergency text via an N2/N3 connection to a 5G Core 520. In the 4G embodiment, the DU 508 sends the emergency text via an S1-MME or S1-U connection to a 4G Core 524. S1-MME and S1-U are sub-interfaces of the S1 interface, which connects the eNodeB and the MME in the EPC. The S1 interface is based on the Stream Control Transmission Protocol (SCTP), which is a secure and reliable transport protocol that can handle multiple streams of data. In both the 5G and 4G embodiments, the emergency text is next transmitted to the emergency service provider 540 (e.g., Intrado) using text over IP technology. Finally, the emergency service provider 540 then forwards the emergency text to a 911 Primary Public Safety Answering Point (PSAP) 545 for emergency handling.

The enhanced SMS-to-emergency system provides the following technological improvements: (1) text-to-emergency service for both registered and unregistered UEs 106, (2) bi-directional communication for UEs 506 both with and without valid SIMs, (3) priority treatment for text-to-emergency services, and (4) real-time UE location tracking. The enhanced SMS-to-emergency system enables carriers to exceed regulatory requirements for public wellbeing (i.e., safety reasons) by supporting text-to-emergency services for both registered and unregistered UEs, including UEs without SIM cards or with invalid SIM cards. In this manner, emergency service entities are able to text back to the UE even if the device has no valid SIM or no SIM at all. This is achieved by maintaining the emergency PDU session as an always-on session. Additionally, the emergency PDU session, which transports the emergency SMS messages, receives prioritized treatment over regular data connections. Furthermore, during the emergency PDU session setup, the packet core performs a network-induced location request (NI-LR), which triggers automated location reporting to emergency service entities. Notably, the enhanced SMS-to-emergency system solution is applicable to all UE categories, fully compliant with 3GPP functional procedures, and supports both user plane and control plane PDU session delivery of text-to-emergency messages.

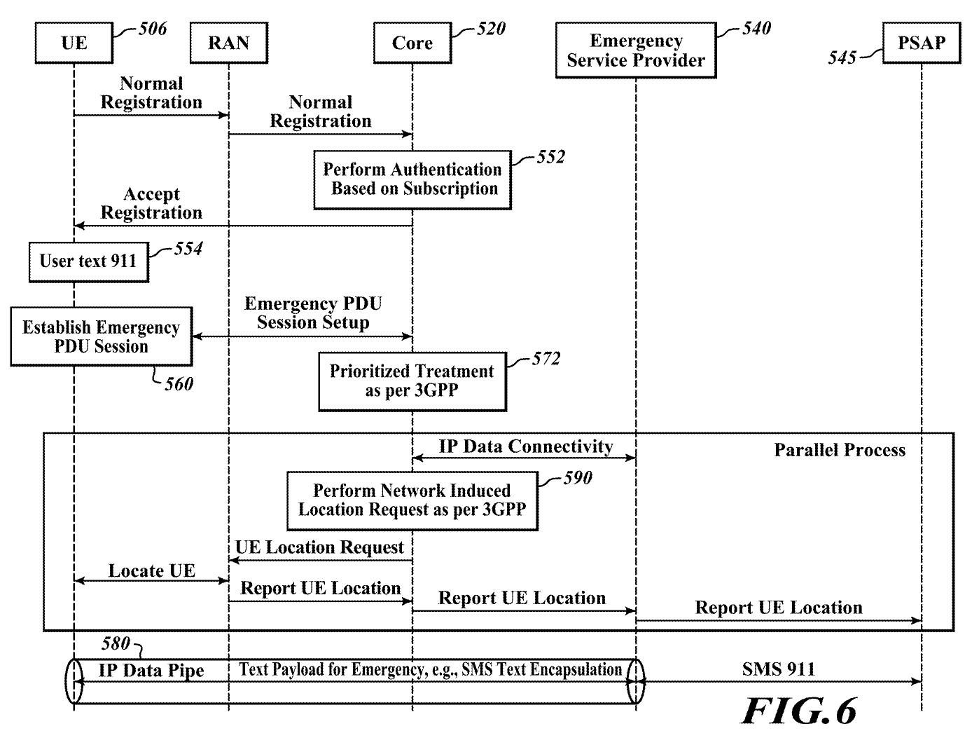

FIG. 6 illustrates a communication flow within a system for providing emergency text service with subscriber identity of network registration in mobile networks. Specifically, FIG. 6 is a flow diagram that shows how technological improvements are achieved for a normal subscribed and registered UE 506. In the embodiment shown in FIG. 6, a UE 506 in the enhanced SMS-to-emergency system sends a registration request to the 5G Core 520. The 5G Core 520 then performs authentication based on the subscription 552, which results in the acceptance of the registration. This enables the user to send an emergency 911 text 554.

As shown in FIG. 6, the enhanced SMS-to-emergency system enables a UE 506 to establish an emergency PDU session 560 towards the mobile packet 5G Core 520 according to standard 3GPP procedures, and to transmit the emergency text messages as payload of the established IP user plane. The emergency PDU session 560 supports both registered and unregistered UEs 506. The emergency PDU session 560 provides a managed data connection between the UE 506 and the emergency service provider 540, with prioritized treatment 572 of the emergency PDU session over regular data PDU sessions. In this embodiment, emergency SMS messages are transported as data payload over the emergency PDU session 560. As shown in FIG. 6, the text payload for emergency services (e.g., SMS emergency text) is encapsulated in a persistent (i.e., continuous connection) IP data pipe 580 that transmits the encapsulated payload from the UEs 506 to the emergency service provider 540. The emergency service provider 540 in turn transmits the emergency text messages to the Public Safety Answering Point (PSAP) 545.

Additionally, in the enhanced SMS-to-emergency system, the packet core performs network-induced location requests (NI-LR) 590 during the emergency PDU session setup, thereby enabling automated location reporting. As shown in FIG. 6, the network-induced location requests 590 are performed as a parallel process. Notably, the 5G Core 520 and the emergency service provider 540 have IP data connectivity. Thus, the 5G Core 520 performs the network-induced location request (NI-LR) 590 by sending a UE location request through the RAN to the UE 506, which locates the UE 506 and reports the UE location through the RAN, 5G Core 520, and emergency service provider 540, all the way to the PSAP 545 as a parallel process. The emergency PDU session 560 is maintained as always-on, allowing emergency service entities to communicate with the UE 506 even without a valid SIM card.

In this manner, the enhanced SMS-to-emergency system leverages the emergency PDU session 560 to transport an emergency text. Additionally, the enhanced SMS-to-emergency system effectively gives priority treatment to the emergency text payload by leveraging the priority treatment for an emergency PDU session. Further, the enhanced SMS-to-emergency system effectively enables early-on UE location reporting by leveraging the emergency PDU session triggered Network Induced Location Request (NI-LR) process.

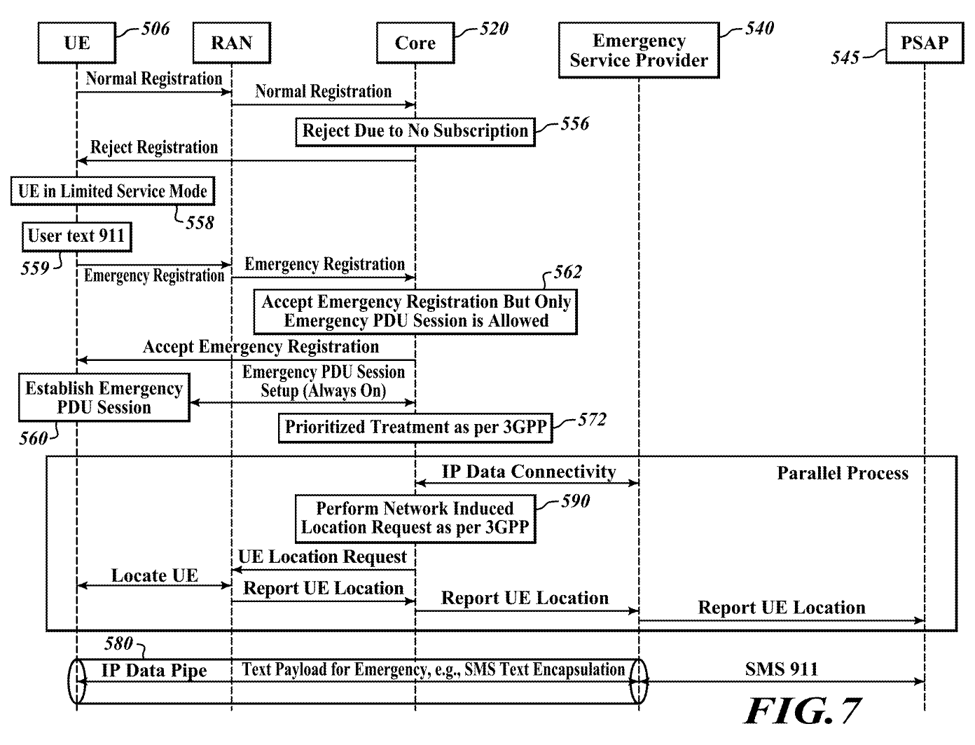

FIG. 7 illustrates a communication flow within a system for providing emergency text service without subscriber identity of network registration in mobile networks. Specifically, FIG. 7 shows how emergency text service can be provided to an unregistered UE in case of emergency. In the embodiment shown in FIG. 7, a UE 506 in the enhanced SMS-to-emergency system sends a registration request to the 5G Core 520. However, in this embodiment, the 5G Core 520 then rejects the authentication based on there being no subscription 556, which results in the rejection of the registration. This rejected registration result places the UE 506 in a limited service mode 558 (i.e., emergency registration). However, the enhanced SMS-to-emergency system still enables the user to send an emergency 911 text 559, even in limited service mode 558. Specifically, the limited service mode 558 enables an emergency registration request to be made that is acknowledged with an emergency registration acceptance 562. Notably, the emergency registration acceptance 562 only enables an emergency PDU session to be made with the UE 506 in a limited service mode 558 (i.e., the emergency registered UE 506).

As shown in FIG. 7, the enhanced SMS-to-emergency system enables a UE 506 to establish an emergency PDU session 560 towards the mobile packet 5G Core 520 according to standard 3GPP procedures, and to transmit the emergency text messages as payload of IP data connectivity as established by PDU session 560. The emergency PDU session 560 provides a managed data connection between the UE 506 and the emergency service provider 540, with prioritized treatment 572 of the emergency PDU session 560 over regular non-emergency PDU data connections. In this embodiment, emergency SMS messages are transported as data payload over the emergency PDU session 560. As shown in FIG. 7, the text payload for emergency services (e.g., SMS emergency text) is encapsulated in a persistent IP data pipe 580 that transmits the encapsulated payload from the UEs 506 to the emergency service provider 540. The emergency service provider 540 in turn transmits the emergency text messages to the Public Safety Answering Point (PSAP) 545.

Additionally, in the enhanced SMS-to-emergency system, the packet core performs network-induced location requests (NI-LR) 590 during the emergency PDU session setup, thereby enabling automated location reporting. As shown in FIG. 7, the network-induced location requests 590 are performed as a parallel process. Notably, the 5G Core 520 and the emergency service provider 540 have IP data connectivity. Thus, the 5G Core 520 performs the network-induced location request (NI-LR) 590 by sending a UE location request through the RAN to the UE 506, which locates the UE 506 and reports the UE location through the RAN, 5G Core 520, and emergency service provider 540, all the way to the PSAP 545 as a parallel process. The emergency PDU session 560 is maintained as always-on, allowing emergency service entities to communicate with the UE 506 even without a valid SIM card.

While above solutions are targeted towards human interfaced mobile UE originated emergency text service, this disclosure further expands the innovation towards IoT space, where an IoT device automatically triggers emergency reporting based on detection of a hazardous environment or combination of abnormal events.

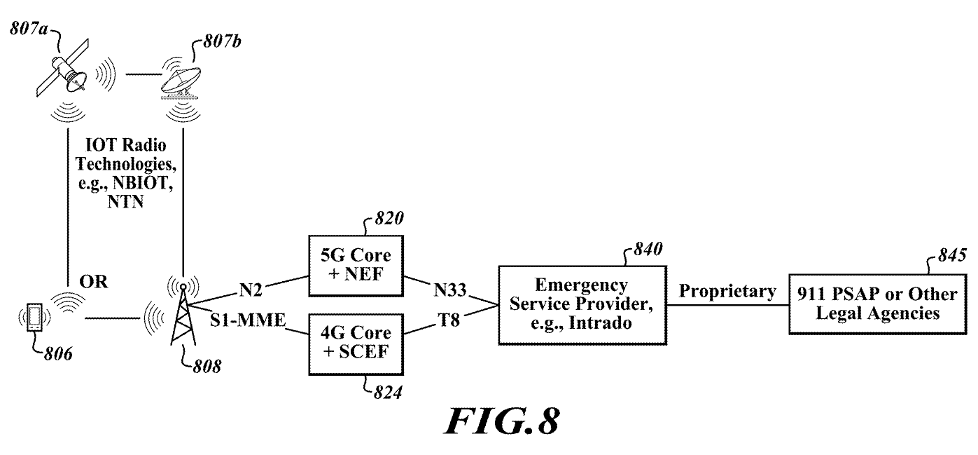

FIG. 8 illustrates a diagram of a system for providing emergency IoT service with or without subscriber identity of network registration in mobile networks using SMS over unstructured data delivery mechanism. Unstructured data delivery mechanism avoids IP header overhead for more efficient data delivery, as well as lower the cost on NBIoT device as IP protocol stack does not need to be implemented in the device, allowing device form factor to fit into resource constraints and economic (price) constraint of NBIOT device.

Specifically, FIG. 8 shows the architecture context of text-to-emergency service in the IoT world, as well as the adapted service flows that are unique for IoT services. The architecture diagram of FIG. 8 shows the end-to-end IoT systems, where an IoT device can connect to various options of narrow band 3GPP radio technology including but not limited to: (1) NTN radio connection, (2) Narrow-Band IoT, and (3) LTE-M. IoT device leverages existing NIDD stack to support emergency payload. This avoids the added complexity and burden of having additional protocol stacks (e.g., IP stacks) to support emergency payload for the IoT device. In these embodiments of a system for providing emergency IoT service with or without subscriber identity of network registration in mobile networks, sensors are employed that can detect emergency situations without human interaction. In these embodiments, the IoT device 806 sends an emergency text message when an emergency situation has been detected by the sensors, all without requiring human interaction.

In one embodiment of the enhanced SMS-to-emergency system configuration, an IoT device 806 sends an emergency text to a RAN 808. In another such embodiment, an IoT device 806 sends an emergency text to satellite 807a that is in turn transmitted to a satellite receiver 807b, and finally sent to the RAN 808. This transmission may be any IoT radio technology with spectrum limitations, e.g., NBIoT, NTN, or the like. In a 5G embodiment, the RAN 808 sends the emergency text via an N2 connection to a 5G Core 820. In the 4G embodiment, the RAN 808 sends the emergency text via an S1-MME to a 4G Core 824. The S1 interface is based on the Stream Control Transmission Protocol (SCTP), which is a secure and reliable transport protocol that can handle multiple streams of data. In the 5G embodiment, the emergency text is next transmitted to the Emergency Service Provider 840 (e.g., Intrado) using an N33 connection. In the 4G embodiments, the emergency text is next transmitted to the Emergency Service Provider 840 (e.g., Intrado) using a T8 connection. Thus, existing IoT 5G Core functions (NEF) and 4G Core functions (SCEF) integrate with Emergency service providers via the 3GPP N33 and T8 interface, respectively. Finally, the Emergency Service Provider 840 then forwards the emergency text to a 911 PSAP 845 for emergency handling.

The NIDD PDU session flows described below are used to deliver the IoT emergency payload from radio, to the core, and to the emergency service provider platform. The platform then translates and delivers the emergency payload to PSAP or other Legal Agencies in an agreed proprietary format. In this system for enhanced IoT SMS-to-emergency services, IoT devices 806 that are supported use non-IP based data connections, such as industrial sensors, home security sensors, sensors in power transmission plants, non-5G data connections (e.g., narrowband device connections), sensors with non-continuous connections, sensors without IP stacks, and devices with limited bandwidth. Notably, such IoT devices 806 supported by the system for enhanced IoT SMS-to-emergency services are wide area compatible, function outdoors, operate on narrowband IoT networks, and do not require a hub. A system that requires hub support, indoor environments, and/or local network support has many functional deficiencies that prevent successful implementation.

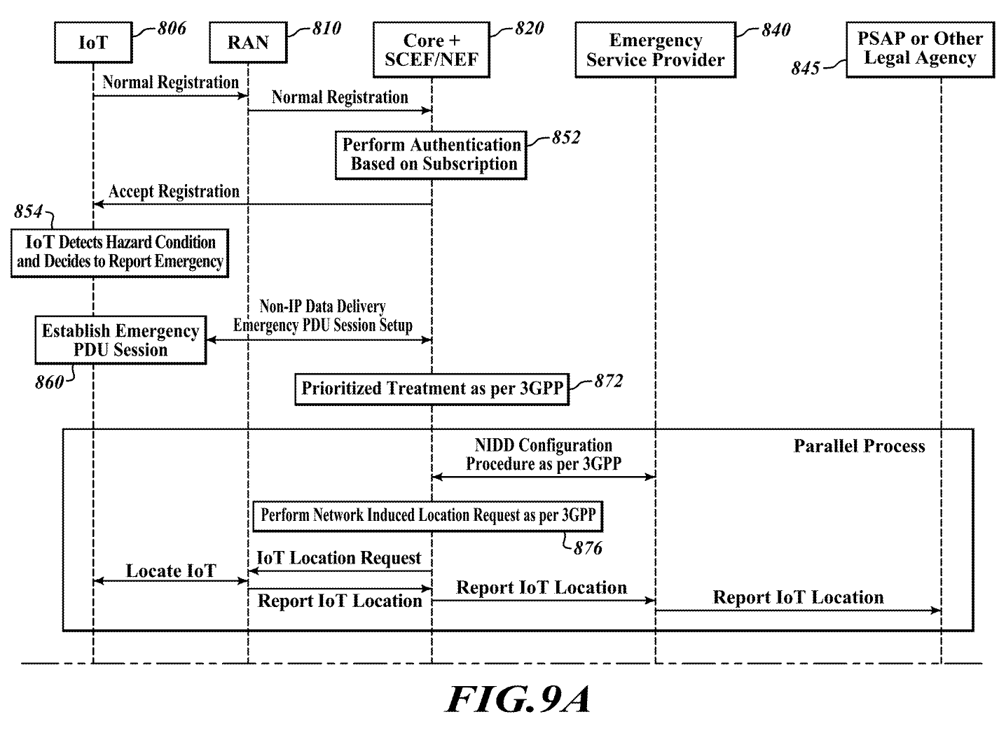

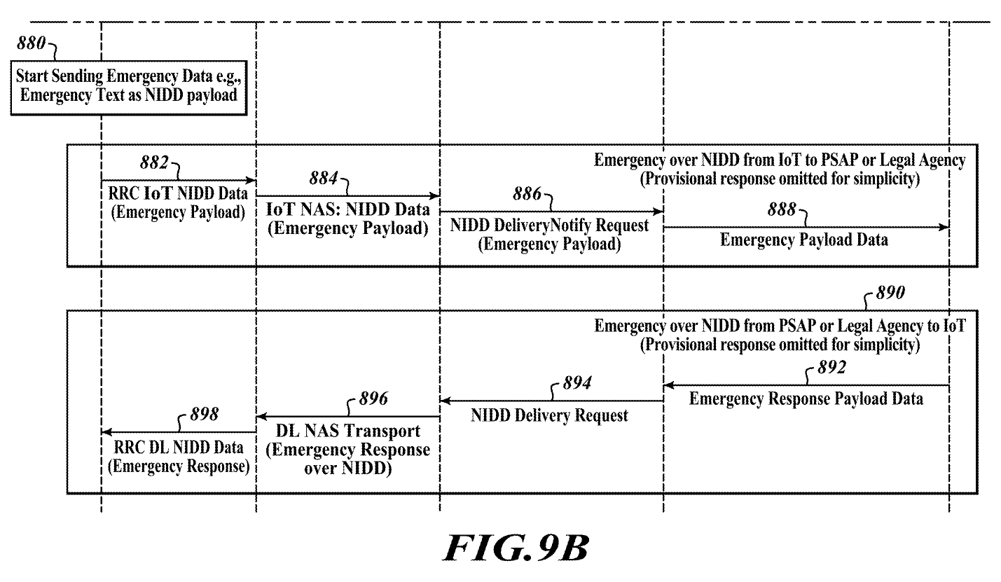

FIGS. 9A and 9B illustrate a communication flow within a system for providing emergency IoT service with subscriber identity of network registration in mobile networks. Specifically, FIGS. 9A and 9B show how an emergency payload is delivered for a subscribed and registered IoT device 806. In the embodiment shown in FIGS. 9A and 9B, an IoT device (hereinafter “IoT”) 806 in the enhanced IoT SMS-to-emergency system sends a registration request to the 5G Core 820. The 5G Core 820 then performs authentication based on the subscription 852, which results in the acceptance of the registration. This enables the IoT 806 to send an emergency 911 text 854.

As shown in FIGS. 9A and 9B, the enhanced IoT SMS-to-emergency system enables an IoT device 806 to establish an emergency PDU session 860 towards the mobile packet 5G Core 820 according to standard 3GPP procedures, and to transmit the emergency text messages as payload of PDU session 860. The emergency PDU session 860 supports both registered and unregistered IoT devices 806. The emergency PDU session 860 provides a managed non-IP data connection between the IoT device 806 and the emergency service provider 840, with prioritized treatment 872 of the emergency text messages over regular data connections. In this embodiment, emergency SMS messages are transported as non-IP data payload over the emergency PDU session 860.

Additionally, in the enhanced IoT SMS-to-emergency system, the packet core performs network-induced location requests (NI-LR) 876 during the emergency PDU session setup, thereby enabling automated location reporting. As shown in FIG. 9, the network-induced location requests 876 are performed as a parallel process. Notably, the 5G Core 820 and the emergency service provider 840 have non-IP data connectivity. Thus, the 5G Core 820 performs the network-induced location request (NI-LR) 876 by sending a IoT location request through the RAN to the IoT 806, which locates the IoT 806 and reports the IoT location through the RAN, 5G Core 820, and emergency service provider 840, all the way to the PSAP 845 as a parallel process. The emergency PDU session 860 is maintained as always-on, allowing emergency service entities to communicate with the IoT 806 even without a valid SIM card.

Furthermore, in the enhanced IoT SMS-to-emergency system, the IoT 806 starts sending emergency data (e.g., emergency text as Non-IP Data Delivery (NIDD) payload) 880 using NIDD to the PSAP 845. First, the IoT 806 sends RRC UL NIDD data (i.e., emergency payload) to the RAN 810, at operation 882. Next, the RAN 810 sends UL NAS NIDD data (i.e., emergency payload) to the 5G Core 820, at operation 884. Then, the 5G Core 820 sends a NIDD Delivery Notify Request (i.e., emergency payload) to the emergency service provider 840, at operation 886. Lastly, the emergency service provider 840 sends the emergency payload data to the PSAP 845, at operation 888.

Moreover, in the enhanced IoT SMS-to-emergency system, the PSAP 845 sends an emergency response (e.g., emergency text as Non-IP Data Delivery (NIDD) payload) 890 using NIDD to the IoT 806. First, the PSAP 845 sends the emergency response payload data to the emergency service provider 840, at operation 892. Next, the emergency service provider 840 sends a NIDD Delivery Notify Request to the 5G Core 820, at operation 894. Then, the 5G Core 820 sends a DL NAS Transport (i.e., emergency response over NIDD) to the RAN 810, at operation 896. Lastly, the RAN 810 sends RRC DL NIDD data (i.e., emergency response) to the IoT 806, at operation 898.

In some embodiments of the enhanced IoT SMS-to-emergency system, the system employes Standard 3GPP Access. However, in other embodiments of the enhanced IoT SMS-to-emergency system, Non-3GPP Access such as Wi-Fi may be implemented as long as this communication protocol integrates with the 5G Core 820. In another aspect of the enhanced IoT SMS-to-emergency system, IoT emergency payload is riding on an emergency NIDD PDU session with standard prioritized treatment. In still another aspect of the enhanced IoT SMS-to-emergency system, the system enables early on IoT UE location reporting, as well as two-way emergency payload and response between IoT UE and PSAP (or other legal agency).

There are many exemplary use cases that leverage the enhanced IoT SMS-to-emergency system for a subscribed and registered IoT 806. In one such embodiment, the enhanced IoT SMS-to-emergency system is employed in indoor or outdoor wide area environments. In another embodiment, the enhanced IoT SMS-to-emergency system is used with IoTs, such as environmental sensors or cameras, e.g., sensors in hydro systems in a remote area, security cameras in warehouse, and the like. In still another embodiment, the enhanced IoT SMS-to-emergency system is used with IoTs, such as stationary sensors where a subscribed radio network is usually available.

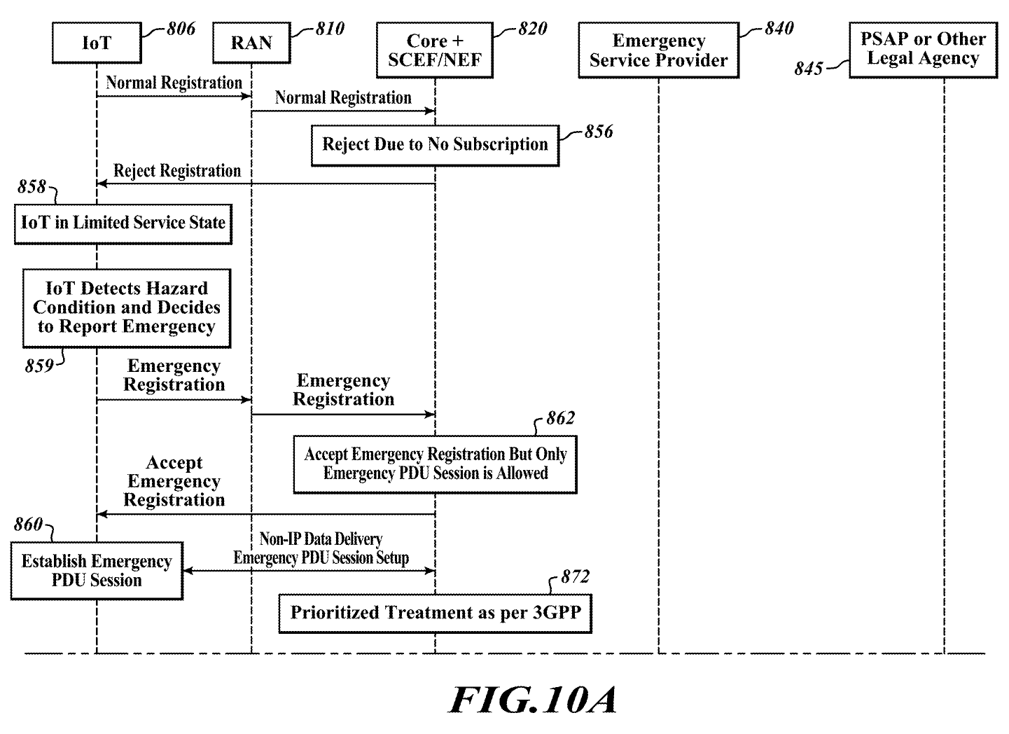

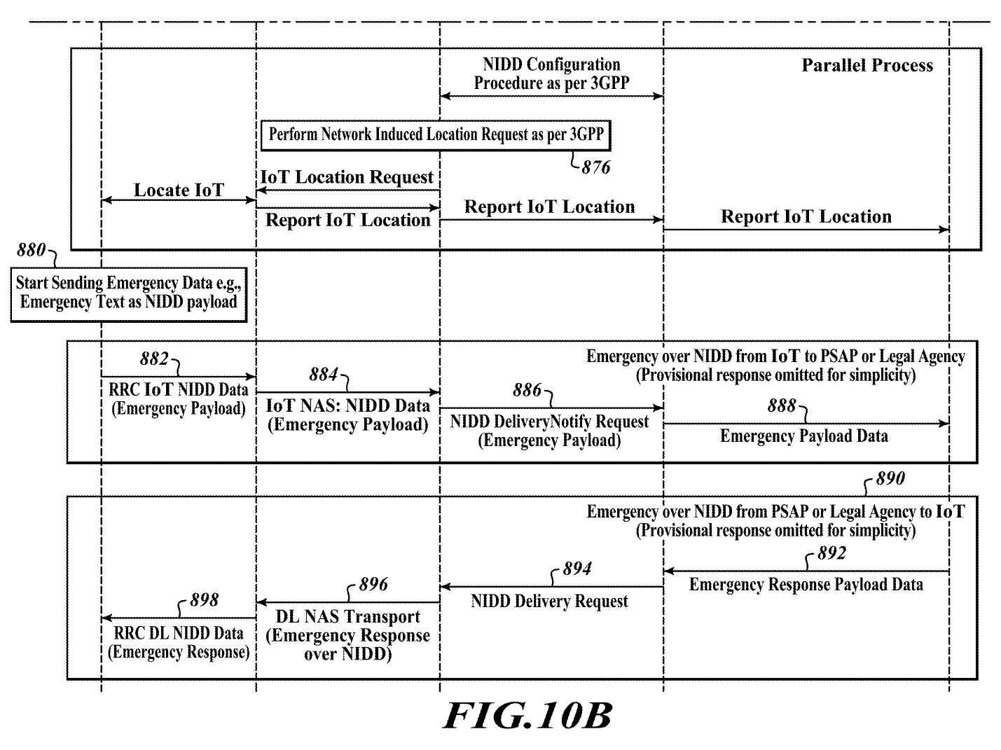

FIGS. 10A and 10B illustrate a communication flow within a system for providing emergency IoT service without subscriber identity of network registration in mobile networks. Specifically, FIGS. 10A and 10B show how an emergency payload is delivered for an unregistered IoT. In the embodiment shown in FIGS. 10A and 10B, an IoT 806 in the enhanced SMS-to-emergency system sends a registration request to the 5G Core 820. However, in this embodiment, the 5G Core 820 then rejects the authentication based on there being no subscription 856, which results in the rejection of the registration. This rejected registration result places the IoT 806 in a limited service mode 858 (i.e., emergency registration). However, the enhanced SMS-to-emergency system still enables the user to send an emergency 911 text 859, even in limited service mode 858. Specifically, the limited service mode 858 enables an emergency registration request to be made that is acknowledged with an emergency registration acceptance 862. Notably, the emergency registration acceptance 862 only enables an emergency PDU session to be made with the IoT 806 in a limited service mode 858 (i.e., the emergency registered IoT 806).

As shown in FIGS. 10A and 10B, the enhanced IoT SMS-to-emergency system enables an IoT 806 to establish an emergency PDU session 860 towards the mobile packet 5G Core 820 to transmit the emergency text messages according to standard 3GPP procedures. The emergency PDU session 860 supports both registered and unregistered IoTs 806. The emergency PDU session 860 provides a managed data connection between the IoT 806 and the emergency service provider 840, with prioritized treatment 872 of the emergency text messages over regular data connections. In this embodiment, emergency SMS messages are transported as data payload over the emergency PDU session 860.

Additionally, in the enhanced IoT SMS-to-emergency system, the packet core performs network-induced location requests (NI-LR) 876 during the emergency PDU session setup, thereby enabling automated location reporting. As shown in FIG. 10, the network-induced location requests 876 are performed as a parallel process. Notably, the 5G Core 820 and the emergency service provider 840 have IP data connectivity. Thus, the 5G Core 820 performs the network-induced location request (NI-LR) 876 by sending a UE location request through the RAN to the IoT 806, which locates the IoT 806 and reports the IoT location through the RAN, 5G Core 820, and emergency service provider 840, all the way to the PSAP 845 as a parallel process. The emergency PDU session 860 is maintained as always-on, allowing emergency service entities to communicate with the IoT 806 even without a valid SIM card.

Furthermore, in the enhanced IoT SMS-to-emergency system, the IoT 806 starts sending emergency data (e.g., emergency text as Non-IP Data Delivery (NIDD) payload) 880 using NIDD to the PSAP 845. First, the IoT 806 sends RRC UL NIDD data (i.e., emergency payload) to the RAN 810, at operation 882. Next, the RAN 810 sends UL NAS NIDD data (i.e., emergency payload) to the 5G Core 820, at operation 884. Then, the 5G Core 820 sends a NIDD Delivery Notify Request (i.e., emergency payload) to the emergency service provider 840, at operation 886. Lastly, the emergency service provider 840 sends the emergency payload data to the PSAP 845, at operation 888.

Moreover, in the enhanced IoT SMS-to-emergency system, the PSAP 845 sends an emergency response (e.g., emergency text as Non-IP Data Delivery (NIDD) payload) 890 using NIDD to the IoT 806. First, the PSAP 845 sends the emergency response payload data to the emergency service provider 840, at operation 892. Next, the emergency service provider 840 sends a NIDD Delivery Notify Request to the 5G Core 820, at operation 894. Then, the 5G Core 820 sends a DL NAS Transport (i.e., emergency response over NIDD) to the RAN 810, at operation 896. Lastly, the RAN 810 sends RRC DL NIDD data (i.e., emergency response) to the IoT 806, at operation 898.

There are many exemplary use cases that leverage the enhanced IoT SMS-to-emergency system for an emergency registered IoT 806. In one such embodiment, the enhanced IoT SMS-to-emergency system is employed in mostly outdoor wide area environments. In another embodiment, the enhanced IoT SMS-to-emergency system is used with IoTs, such as smart-transportation or smart-flight sensors where the sensors are typically in motion. In still another embodiment, the enhanced IoT SMS-to-emergency system is used with IoTs, such as nomadic sensors where a prior subscription to serving radio network cannot be guaranteed.

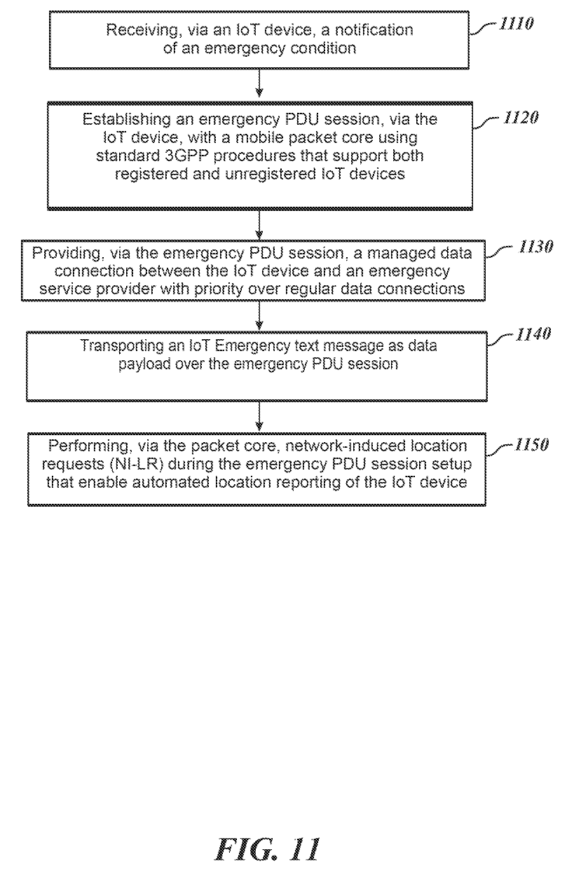

FIG. 11 is a logic diagram showing a system for providing emergency text service without subscriber identity of network registration in mobile networks. As shown in FIG. 11, at operation 1110, the method includes identifying, via an IoT device, an emergency condition. At operation 1120, the method includes establishing an emergency PDU session, via the IoT device, with a mobile packet core using standard 3GPP procedures that support both registered and unregistered IoT devices. At operation 1130, the method includes providing, via the emergency PDU session, a managed data connection between the IoT device and an emergency service provider with priority over regular data connections. At operation 1140, the method includes transporting an IoT emergency text message as data payload over the emergency PDU session. At operation 1150, the method includes performing, via the packet core, network-induced location requests (NI-LR) during the emergency PDU session setup that enable automated location reporting of the IoT device.

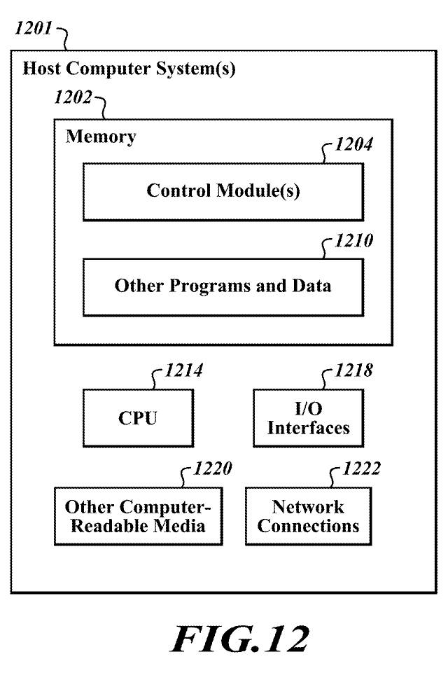

FIG. 12 shows a system diagram that describes an example implementation of a computing system(s) for implementing embodiments described herein. The functionality described herein for a system for providing emergency IoT service without subscriber identity of network registration in mobile networks, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is example host computer system(s) 1201. For example, such computer system(s) 1201 may represent those in various data centers and cell sites shown and/or described herein that host the functions, components, microservices and other aspects described herein to implement a system for providing emergency IoT service without subscriber identity of network registration in mobile networks. In some embodiments, one or more special-purpose computing systems may be used to implement the functionality described herein. Accordingly, various embodiments described herein may be implemented in software, hardware, firmware, or in some combination thereof. Host computer system(s) 1201 may include memory 1202, one or more central processing units (CPUs) 1214, I/O interfaces 1218, other computer-readable media 1220, and network connections 1222.

Memory 1202 may include one or more various types of non-volatile and/or volatile storage technologies. Examples of memory 1202 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 1202 may be utilized to store information, including computer-readable instructions that are utilized by CPU 1214 to perform actions, including those of embodiments described herein.

Memory 1202 may have stored thereon control module(s) 1204. The control module(s) 1204 may be configured to implement and/or perform some or all of the functions of the systems, components and modules described herein for a system for providing emergency IoT service without subscriber identity of network registration in mobile networks. Memory 1202 may also store other programs and data 1210, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 1222 are configured to communicate with other computing devices to facilitate the functionality described herein. In various embodiments, the network connections 1222 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1218 may include a video interface, other data input or output interfaces, or the like. Other computer-readable media 1220 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, via an Internet of Things (IoT) device, a notification of an emergency condition;
establishing an emergency Protocol Data Unit (PDU) session between the IoT device and a mobile packet core that support both registered and unregistered IoT devices;
providing, via the emergency PDU session, a managed data connection between the IoT device and an emergency service provider with priority over regular data connections;
transporting an IoT Emergency text message as data payload over the emergency PDU session via the managed data connection; and
performing, via the mobile packet core, Network-Induced Location Requests (NI-LR) during the emergency PDU session setup that enable automated location reporting of the IoT device to the emergency service provider.

2. The method of claim 1, wherein the IoT device includes a sensor that is selected from one or more of: an industrial sensor, a power transmission plant sensor, a home security sensor, a vehicle sensor, or an aircraft sensor.

3. The method of claim 1, further comprising: sending the IoT Emergency text message using non-IP stack based communication.

4. The method of claim 3, wherein the non-IP stack based communication is one or more of: narrowband IoT network communication, non-continuous communication, limited bandwidth communication, wide area communication, hub-free communication, and NIDD communication.

5. The method of claim 1, further comprising: providing priority treatment to the emergency text payload by leveraging priority treatment for the emergency PDU session.

6. The method of claim 1, further comprising: providing IoT device location reporting by leveraging the emergency PDU session triggered Network Induced Location Request (NI-LR) process.

7. The method of claim 1, further comprising: enabling unregistered IoT devices to perform emergency registration towards the core network.

8. The method of claim 1, further comprising: enabling emergency registration of the IoT device without requiring subscription authentication with the mobile packet core.

9. The method of claim 1, further comprising: enabling an emergency PDU session from an emergency registered IoT device, and preventing an emergency PDU session from IoT devices other than the emergency registered IoT device.

10. A system for providing Internet of Things (IoT) emergency text service, the system comprising:
a memory that stores computer-executable instructions; and
a processor that executes the computer-executable instructions that cause the processor to:
establish an emergency Protocol Data Unit (PDU) session between the IoT device and a mobile packet core that support both registered and unregistered IoT devices;
provide, via the emergency PDU session, a managed data connection between the IoT device and an emergency service provider with priority over regular data connections;
transport an IoT Emergency text message as data payload over the emergency PDU session via the managed data connection; and
perform, via the mobile packet core, network-induced location requests (NI-LR) during the emergency PDU session setup that enable automated location reporting of the IoT device to the emergency service provider.

11. The system of claim 10, wherein the IoT device includes a sensor that is selected from one or more of: an industrial sensor, a power transmission plant sensor, a home security sensor, a vehicle sensor, or an aircraft sensor.

12. The system of claim 10, wherein emergency SMS messages are sent using non-IP stack based communication.

13. The system of claim 12, wherein the non-IP stack based communication is one or more of: narrowband IoT network communication, non-continuous communication, limited bandwidth communication, wide area communication, hub-free communication, and NIDD communication.

14. The system of claim 10, wherein priority treatment is provided to the emergency text payload by leveraging priority treatment for the emergency PDU session.

15. The system of claim 10, wherein IoT device location reporting is provided by leveraging the emergency PDU session triggered Network Induced Location Request (NI-LR) process.

16. The system of claim 10, wherein the system enables unregistered IoT devices to perform emergency registration towards the core network.

17. The system of claim 10, wherein the system enables emergency registration of the IoT device without requiring subscription authentication with the mobile packet core.

18. The system of claim 10, wherein the system enables an emergency PDU session from an emergency registered IoT device, and preventing an emergency PDU session from IoT devices other than the emergency registered IoT device.

19. A non-transitory computer-readable storage medium having computer-executable instructions stored thereon that, when executed by a processor, cause the processor to:
establish an emergency Protocol Data Unit (PDU) session between the Internet of Things (IoT) device and a mobile packet core that support both registered and unregistered IoT devices;
provide, via the emergency PDU session, a managed data connection between the IoT device and an emergency service provider with priority over regular data connections; and
transport an IoT Emergency text message as data payload over the emergency PDU session via the managed data connection.

20. The non-transitory computer-readable storage medium of claim 19, wherein computer-executable instructions stored thereon that, when executed by a processor, cause the processor to: perform, via the mobile packet core, network-induced location requests (NI-LR) during the emergency PDU session setup that enable automated location reporting of the IoT device to the emergency service provider.
